(19) United States
(12) Patent Application Publication
(10) Pub. No.: US 2007/0240834 A1
(43) Pub. Date: Oct. 18, 2007

(54) Displaceable from the opening sectioned door with track supporting post

(76) Inventor: Jozsef Kiss, Mihaly (HU)

Correspondence Address: YOUNG & THOMPSON, 745 SOUTH 23RD STREET, 2ND FLOOR, ARLINGTON, VA, 22202, US

(21) Appl. No.: 11/408,174

(22) Filed: Apr. 21, 2006

(30) Foreign Application Priority Data
Apr. 18, 2006 (HU) P 0600306

(51) Int. Cl. E05D 15/00

(52) U.S. Cl. 160/201

(57) ABSTRACT

A displaceable from the opening sectioned door with track supporting post, which is fixed in a position determined by the plane and dividing lines of the opening using a detachable fixing mechanism, at the two sides of the track supporting post and up to the full height of the opening vertical guiding tracks of individually known and widely used width sectioned doors are fixed, allowing the upper end of the track supporting post, whose load bearing capacity corresponds with the size and mechanism of the sectioned door used—in a closed state and the vertical guiding tracks attached to the fixed horizontal guiding tracks with an upper fixing mechanism ensuring precise connection,—permitting sideways sliding, suspended on a roller gear over the horizontal pole guiding track, while its lower end connects to the base via a lower fixing mechanism.

Subject of the invention is a displaceable from the opening sectioned door with track supporting post, a mechanism offering suitable technical solution for enclosing large door openings on large buildings in an up-to-date, heat insulated and sealed manner by using sectioned doors, which also enables segmenting of large openings into several smaller size ones.

Currently sectioned doors are regarded the most advanced technical solutions, are used world-wide and, thanks to their advantageous features, one could state that are the most widely spread types used in applications ranging from garage doors up to the doors of industrial halls. The size of an opening that can be cost efficiently enclosed using a sectioned door is limited, however, by the technical parameters of basically inexpensive components produced on a large scale because for especially large openings a sectioned door would come extremely expensive, heavy and difficult to transport due to the unique components it requires. For this reason, currently other than sectioned doors are used for enclosing large openings such as multi-panel sliding or so called accordion system doors, which do not offer all the advantages of sectioned doors. For instance, the sealing of slide doors is generally insufficient, their use normally requires suitable space along the internal or external wall plane to accommodate the sliding panels and, in the case of the accordion doors, on top of the sealing problems comes the expensive motor drive issue for moving the rather complex mechanism.

Dividing a single large opening into several smaller sections seems to be much more sensible approach because that allows the installation of commercially and widely available generic doors. A solution based upon similar principle is already in use at Hódmez\acute{ó}vásárhely, at Metal Processing Co. (Fémtechnikai Rt.), where the firm installed so called telescopic doors of its own manufacture and is able to enclose openings larger than what could be enclosed using the currently commercially available maximum width panels, under the name: gate system. Due to several reasons, however, these telescopic doors cannot be regarded modem enough. Irresolvable heat insulation, sealing, noise and aesthetical problems arise mainly because of the design itself.

Sectioned doors have managed to cease most of the above-mentioned problems and hence can be regarded up-to-date designs with the only disadvantage remaining that the size is currently limited due to which such doors are insufficient for enclosing door openings of large halls.

Our goal with this invention was to create a door mechanism, which can be regarded as the currently modern type and would be suitable for the provision of modern and heat insulated and sealed enclosing mechanism for large openings of large industrial halls—preferably airplane hangars—and shipyards, where the otherwise widely used modem sectioned doors cannot be used due to the size limitation of their maximum production width.

The invention is based upon the realization that large openings can be divided into several smaller ones the size of which is not too large anymore to allow enclosing by cost efficiently produced, well sealed sectioned doors.

This way the only factor limiting the size of the opening allowing free traffic is the greatest span of the building's structure i.e. it may be the multiple of the width of a sectioned door. With this solution one can install sectioned doors with the usual and widely used sizes, mechanisms and design. We implement the distribution into sections using mobile track supporting posts, which keep the vertical guiding tracks of the sectioned door in the division line of the opening, hence the load bearing element becomes a mobile pillar that also distributes wind load and turns the whole door structure into a hurricane-proof mechanism.

Subject of the invention therefore is a displaceable from the opening sectioned door with track supporting post, the track supporting post of which is fixed in a position determined by the plane and dividing lines of the opening using a detachable fixing mechanism, at the two sides of the track supporting post and up to the full height of the opening vertical guiding tracks of individually known and widely used width sectioned doors are fixed, in a manner allowing the upper end of the track supporting post, the load bearing capacity of which corresponds with the size and mechanism of the sectioned door used—in a closed state of the sectioned door and the vertical guiding tracks attached to the fixed horizontal guiding tracks with an upper fixing mechanism ensuring precise connection,—in a manner permitting sideways sliding, suspended on a roller gear over the horizontal pole guiding track, while its lower end connects to the base via a lower fixing mechanism.

In an advantageous design example of the displaceable from the opening sectioned door with track supporting post that is the subject of this invention the lower,—upper fixing mechanisms are mechanical, electrical or electromechanical.

In another advantageous example of the displaceable from the opening with track supporting post sectioned door that is the subject of this invention at the lower or upper fixing point a sensor detecting the fixed position by electric sensing exists, which is connected to the operation inhibiting input of the electronic unit controlling the motor driven operation of the sectioned doors.

We provide drawings to facilitate more detailed explanation of the solution covered in this invention.

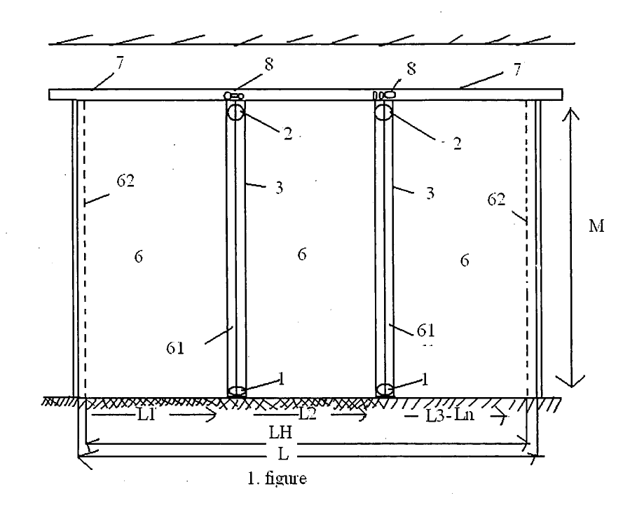

FIG. 1 shows front view of the door discussed in this invention,

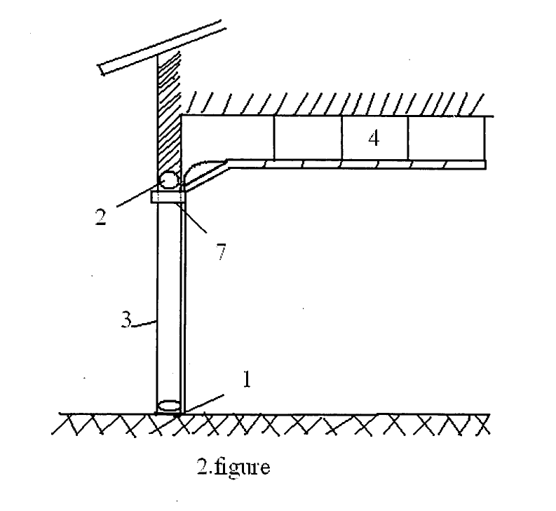

FIG. 2 shows side view of the door discussed in this invention.

The invention is based on the principle of dividing the opening, however, its significant element is the use of modern sectioned doors 5.

In the manner shown in FIG. 1 division of the (L) width, (M) height opening into n number of sections enables the application of relatively simple mechanism, well sealed and heat insulated, easy to fit with motor sectioned doors, assembled of standard size and (L1), (L2), (L3) (Ln) width components for enclosing an especially large opening that equals the size of which may be the multiple of the width of the individual doors. In this case width of the free opening for through traffic is only limited by the largest span of the building structure because the number of divided sections may be optional.

The displaceable from the opening track supporting post 3 discussed in this invention is applied at the divisions of the large opening. In a closed state of the opening all sectioned doors 5 are closed and the track supporting posts 3 keep vertically true the vertical guiding tracks 51 of the sectioned doors 5 in the plane of the opening and in the line of the division between the sectioned doors, naturally, with the exception of the fixed guiding tracks 52 at the two edges of the total opening.

In the Figure it is apparent that the two track supporting posts 3 divide the broad opening into three equal sections, at the two ends of the track supporting post 3 lower,—upper 1,-2 pole fixing mechanisms are installed, which at the bottom fix the track supporting posts 3 to the base and at the top to the horizontal post guiding track 6. Having closed the door those load the track supporting posts 3 securely fixed at both ends and hence the whole door becomes a hurricane-proof mechanism. Crossbeam 4 over the large opening is also shown, as well as the individually known horizontal post guiding tracks 6 at both sides fixed to it, in which a roller gear 7 provides the sideways sliding of the track supporting post 3 along the wall plane by a mechanical, electrical or electromechanical mechanism.

On the lower 1,—or the upper 2 fixing mechanism of the door that is the subject of this invention a sensor not shown in the figure is fitted, which electrically detects the fixed status and is connected to the inhibiting input of the electronic unit controlling the motor driven operation of the sectioned door 5 and prevents the motor driven movement of the sectional door 5 when the track supporting post 3 is displaced from the opening.

The figure shows that the freed useful width of the opening is less by the total width of the fixed vertical guiding track 52 than the total L width of the opening. This condition should be taken into account when designing the opening.

In FIG. 2 the side view clearly shows the fixed horizontal guiding track 8, which is part of the sectioned door 5 and is generally fastened below the ceiling, and in which the panels of the sectioned door 5 slide in an open state. The track supporting post 3 arranged along the plane of the wall is also shown, the lower end of which is fastened to the base by the lower fixing mechanism 1, while the upper end is fastened by the upper fixing mechanism 2 to the horizontal post guiding track 6. Crossbeam 4 above the large opening is also shown, as well as the individually known horizontal post guiding track 6 fixed to it, in which the roller gear 7 not shown in the figure ensures sideways sliding of the track supporting post 3 along the plane of the wall, by mechanical, electrical or electromechanical method.

Operation of the invention is as follows:

When freeing the opening i.e. opening up first all sectioned doors 5 should be completely opened i.e. all panels of the sectioned doors 5 should be displaced in a way that those leave the vertical guide track 5.1 and move over to the fixed horizontal guiding track 8 under the ceiling as shown in FIG. 2. Then the track supporting posts 3 having represented an obstacle up to this point should be slid sideways at which point those become displaceable from the opening by first releasing the lower 1, upper-2 fixing mechanisms. Sliding is performed in both directions inside the individually known and for a long time widely used for slide doors horizontal post guiding track 6 by an also individually known and used roller gear 7 located on the crossbeam 4.

With the sliding performed the whole opening becomes free for traffic allowing objects of sizes matching the opening to be moved into and out from the building. The track supporting posts 3 can be displaced by hand or by mechanical drive subject to the building structure or other circumstances.

By using the solution discussed in this invention enclosing of the opening requires carrying out the above-discussed steps in a reverse order. First the track supporting posts 3 that are the subject of this invention should be moved back fully to their respective initial locations in the distribution lines of the opening and then should be fastened there in place. Hence the vertical guide tracks 51 and the fixed horizontal guiding tracks 8 of the sectioned doors 5 normally arranged under the ceiling in the manner shown in FIG. 2 are interconnected at the upper ends of the track supporting posts 3 using the fixing mechanism 2 and hence recreating the track necessary for their movement. Then by closing the sectioned doors 5 the whole opening can be enclosed. A further advantage of distributing the opening by the track supporting posts 3 discussed in this invention is that a partial opening becomes possible. When only smaller size objects need moving, which can be moved through the sectioned door 5 of only one section of the divided opening, it is sufficient to open only one such door up to the required height. Compared to the use of a single large door this may result in significant savings of heating energy and time.

Advantages of my invention i.e. the displaceable from the opening sectioned door with track supporting post are as follows:
by removing the track supporting posts openings much larger than before can be made free,
the possibility opens up for partial opening whenever smaller size objects need to be moved and hence
it can result in significant heating energy and time savings compared to the use of a single large door,
due to the fixing of track supporting posts and the load imposed on it by the sectioned door the structure becomes hurricane-proof.

### List of Definitions

1. Lower fixing mechanism
2. Upper fixing mechanism
3. Track supporting post
4. Crossbeam
5. Sectioned door
   51. Vertical guide track
   52. Fixed vertical guide track
6. Horizontal post guiding track
7. Roller gear
8. Fixed horizontal guiding track

1./ Displaceable from the opening sectioned door with track supporting post, where the track supporting post is fixed by a detachable fixing in a position determined by the plane of the opening and the division lines, and vertical guide tracks of individually known and used width sectioned doors are mounted on the two sides of the track supporting post up to the full height of the opening, characterized by the fact that the upper end of the track supporting post (3) having a load bearing capacity matching the size and structure of the sectioned door (5)—in a closed state of the sectioned door (5) fastening its vertical guide tracks (51) to the fixed horizontal guiding tracks (8) by an upper fixing mechanism (2) that provides precise connection,—in a manner that it could be slid sideways, suspended on a roller gear (7) on the horizontal post guiding track (6), and at the lower end it is connected to the base by a lower fixing mechanism (1).

2./ The door as per claim 1, characterized by the fact that the lower,-upper fixing mechanisms (1,-2.) are mechanical, electrical or electromechanical.

3./ The door as per claim 1, characterized by the fact that on the lower, or upper fixing mechanisms (1,2) a sensor exists that electrically detects fixed status and is connected to the operation inhibiting input of the electronic unit controlling the motor driven movement of the sectioned door (5).

4./ The door as per claim 2, characterized by the fact that on the lower, or upper fixing mechanisms (1,2) a sensor exists that electrically detects fixed status and is connected to the operation inhibiting input of the electronic unit controlling the motor driven movement of the sectioned door (5).
